(19) United States
(12) Patent Application Publication
(10) Pub. No.: US 2017/0240183 A1
(43) Pub. Date: Aug. 24, 2017

(54) AUTONOMOUS DRIVING APPARATUS

(71) Applicant: TOYOTA JIDOSHA KABUSHIKI KAISHA, Toyota-shi (JP)

(72) Inventors: Ikuma SUZUKI, Okazaki-shi (JP); Junichi WAKITA, Nagoya-shi (JP); Nobuyuki TOMATSU, Toyota-shi (JP); Akihito NAKAMURA, Toyota-shi (JP)

(73) Assignee: TOYOTA JIDOSHA KABUSHIKI KAISHA, Toyota-shi (JP)

(21) Appl. No.: 15/391,275

(22) Filed: Dec. 27, 2016

(30) Foreign Application Priority Data
Feb. 24, 2016 (JP) 2016-033239

(51) Int. Cl. B60W 50/08; B60W 40/08; B60W 50/10; B60W 50/14; G05D 1/00

(52) U.S. Cl. CPC B60W 50/082; B60W 50/14; G05D 1/0088; B60W 50/10; B60W 40/08; G01S 19/13

(57) ABSTRACT

An autonomous driving apparatus that executes an autonomous driving control of a vehicle is provided. The autonomous driving apparatus includes a tutorial switch and a controller. The controller is configured to: determine whether or not the autonomous driving control can be started; and determine whether or not a tutorial can be started, the tutorial being an explanation of an operation by a driver required for switching from the autonomous driving control to manual driving. A determination condition for determining that the tutorial can be started is less likely to be met than a determination condition for determining that the autonomous driving control can be started. The tutorial is started when the tutorial switch is in ON state and the controller determines that the tutorial can be started.

### BACKGROUND

Technical Field

The present invention relates to an autonomous driving apparatus.

Background Art

An autonomous driving apparatus that executes an autonomous driving control of a vehicle is conventionally known. An example of such the autonomous driving apparatus is described in Patent Literature 1.

According to the autonomous driving apparatus described in Patent Literature 1, when a driver in a vehicle is ready to relinquish control of the vehicle to an autonomous driving computing system or a control computer, the control computer prepares to start the autonomous driving control (armed). More specifically, according to the autonomous driving apparatus described in Patent Literature 1, a button is pressed or a lever is manipulated by the driver in order to prepare to start the autonomous driving control.

That is, according to the autonomous driving apparatus described in Patent Literature 1, the driver's action such as pressing the button or manipulating the lever is an engagement action required for starting the autonomous driving control.

Moreover, Patent Literature 1 describes that when an emergency situation occurs, switching from the autonomous driving control to manual driving is executed in response to a driver's operation such as gripping a steering wheel.

### LIST OF RELATED ART

Patent Literature 1: U.S. Pat. No. 8,670,891

### SUMMARY

Patent Literature 1 describes that switching from the autonomous driving control to the manual driving is executed in response to a driver's operation such as gripping a steering wheel. However, Patent Literature 1 does not refer to an explanation (tutorial) of the driver's operation required for the switching from the autonomous driving control to the manual driving

In a case where there is no explanation of the driver's operation required for the switching from the autonomous driving control to the manual driving, the driver does not know the operation required for the switching from the autonomous driving control to the manual driving, and thus there is a possibility that the switching from the autonomous driving control to the manual driving cannot be executed even though the driver desires the switching from the autonomous driving control to the manual driving.

Moreover, even if there is an explanation (tutorial) of the driver's operation required for the switching from the autonomous driving control to the manual driving, there may be the following problem; that is, if the tutorial is started at an improper timing, the driver may perform, in accordance with the tutorial, the operation required for the switching from the autonomous driving control to the manual driving, even under a situation where safety is insufficient.

The present invention has been made to solve the problem described above. An object of the present invention is to provide an autonomous driving apparatus that can suppress the possibility that the tutorial is started and the driver performs the operation required for the switching from the autonomous driving control to the manual driving under a situation where safety is insufficient.

In an aspect of the present invention, an autonomous driving apparatus that executes an autonomous driving control of a vehicle is provided.

The autonomous driving apparatus includes a tutorial switch and a controller.

The controller is configured to:
determine whether or not the autonomous driving control can be started; and
determine whether or not a tutorial can be started, the tutorial being an explanation of an operation by a driver required for switching from the autonomous driving control to manual driving.

A determination condition for determining that the tutorial can be started is less likely to be met than a determination condition for determining that the autonomous driving control can be started.

The tutorial is started when the tutorial switch is in ON state and the controller determines that the tutorial can be started.

As described above, the autonomous driving apparatus according to the present invention is configured to be able to perform the tutorial that is the explanation of the driver's operation required for the switching from the autonomous driving control to the manual driving. Therefore, in the case of the autonomous driving apparatus according to the present invention, it is possible to suppress the possibility that the switching from the autonomous driving control to the manual driving cannot be executed even though the driver desires the switching from the autonomous driving control to the manual driving, as compared with a case where the autonomous driving apparatus is not configured to be able to perform the tutorial.

Furthermore, according to the autonomous driving apparatus of the present invention, the determination condition for determining that the tutorial can be started is less likely to be met than the determination condition for determining that the autonomous driving control can be started. That is, according to the autonomous driving apparatus of the present invention, the tutorial is started under a safer situation than a situation when the autonomous driving control can be started. In accordance with the tutorial, the driver performs the operation required for the switching from the autonomous driving control to the manual driving.

Therefore, according to the autonomous driving apparatus of the present invention, it is possible to suppress the possibility that the tutorial is started and the driver performs the operation required for the switching from the autonomous driving control to the manual driving under a situation where the safety is insufficient. In other words, according to the autonomous driving apparatus of the present invention, the driver can safely learn and safely perform the operation required for the switching from the autonomous driving control to the manual driving.

In the autonomous driving apparatus according to the present invention, the controller may be further configured to:
generate a plan of navigation carried out by the autonomous driving control;
check, based on the generated plan of navigation, a scheduled action of the autonomous driving apparatus;
generate a scenario;
compare the scheduled action of the autonomous driving apparatus with the scenario to determine whether or not the scheduled action is consistent with the scenario;
recommend, to the driver, a candidate scenario that is the scenario determined to be consistent with the scheduled action of the autonomous driving apparatus and with which the driver can execute the operation required for the switching from the autonomous driving control to the manual driving; and
determine whether or not the recommended candidate scenario is selected by the driver.

The scenario generated by the controller is predetermined.

In this case, the tutorial is started when the controller determines that the scheduled action of the autonomous driving apparatus is consistent with the scenario and the controller determines that the recommended candidate scenario is selected by the driver.

That is, according to the autonomous driving apparatus of the present invention, the tutorial to be started is about the operation recommended by the autonomous driving apparatus as an operation that the driver can execute in safety and selected by the driver, among the driver's operation required for the switching from the autonomous driving control to the manual driving. In other words, according to the autonomous driving apparatus of the present invention, the tutorial to be started is about the operation that is safe and desired by the driver, among the driver's operation required for the switching from the autonomous driving control to the manual driving. In accordance with the tutorial, the driver performs the operation for switching from the autonomous driving control to the manual driving.

Therefore, according to the autonomous driving apparatus of the present invention, it is possible to improve the safety of the driver's operation for switching from the autonomous driving control to the manual driving and to improve the driver's attention to the tutorial, as compared with a case where a tutorial about an operation with low safety or an operation in which the driver's desire is not reflected is started.

In the autonomous driving apparatus according to the present invention, the controller may be further configured to:
analyze characteristics of the driver based on a result of execution of the tutorial; and
change settings of the autonomous driving apparatus based on the characteristics of the driver.

That is, according to the autonomous driving apparatus of the present invention, the characteristics of the driver are analyzed based on the result of execution of the tutorial, and the settings of the autonomous driving apparatus are changed based on the characteristics of the driver.

Therefore, according to the autonomous driving apparatus of the present invention, it is possible to make the settings of the autonomous driving apparatus suitable for the driver and thus improve the driver's confidence in the autonomous driving apparatus, as compared with a case where the settings of the autonomous driving apparatus are not changed based on the characteristics of the driver.

According to the present invention, it is possible to suppress the possibility that the tutorial is started and the driver performs the operation required for the switching from the autonomous driving control to the manual driving under a situation where the safety is insufficient.

### BRIEF DESCRIPTION OF DRAWINGS

FIG. 1 is a schematic configuration diagram of an autonomous driving apparatus according to a first embodiment;

FIG. 2 is a flow chart for explaining a determination of whether or not a tutorial can be started in the autonomous driving apparatus according to the first embodiment;

FIG. 3 is a flow chart for explaining a determination of whether or not a tutorial can be started in the autonomous driving apparatus according to a second embodiment;

FIG. 4 is a schematic configuration diagram of an autonomous driving apparatus according to a third embodiment; and

FIG. 5 is a flow chart for explaining a determination of whether or not a tutorial can be started in the autonomous driving apparatus according to the third embodiment.

### EMBODIMENTS

### First Embodiment

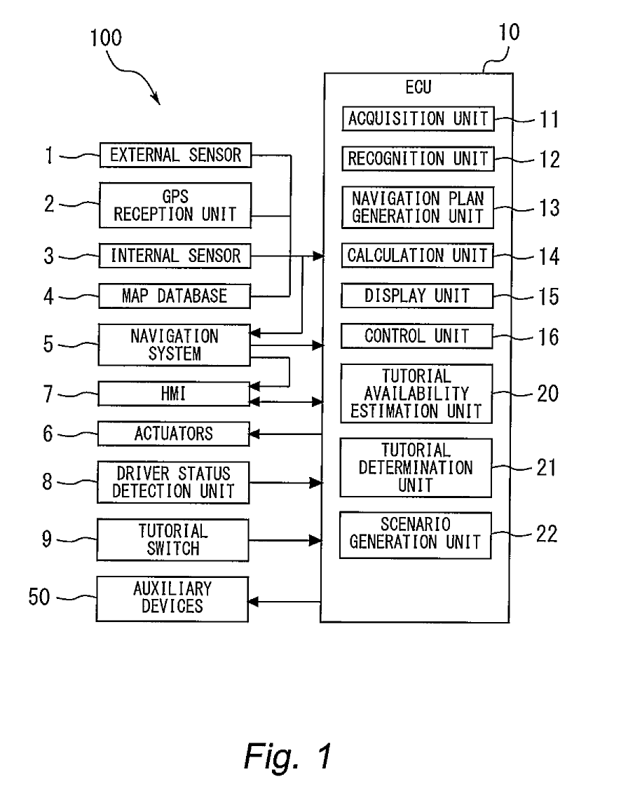

A first embodiment of an autonomous driving apparatus according to the present invention will be described hereinafter. FIG. 1 is a schematic configuration diagram of the autonomous driving apparatus according to the first embodiment.

In the example shown in FIG. 1, the autonomous driving apparatus 100 is installed in a vehicle (not shown) such as a passenger car. The autonomous driving apparatus 100 executes an autonomous driving control of the vehicle. Here, the autonomous driving control means a control that executes driving operations such as acceleration, deceleration and steering of the vehicle without depending on driving operations by a driver of the vehicle.

The autonomous driving control includes a lane keeping assist control as an example. In the lane keeping assist control, a steering wheel (not shown) is steered automatically (namely, without depending on a steering operation by the driver) such that the vehicle does not depart from a running lane. That is, in the lane keeping assist control, the steering wheel is automatically steered such that the vehicle runs along the running lane, even when the driver does not perform any steering operation.

The autonomous driving control includes a navigation control as another example. In the navigation control, when there is no preceding vehicle in front of the vehicle, a constant speed control to make the vehicle run at a predetermined constant speed is executed. When there is a preceding vehicle in front of the vehicle, a follow-up control to adjust a vehicle speed according to a distance between the vehicle and the preceding vehicle is executed.

According to the present embodiment, switching from the autonomous driving control to manual driving is executed. Whether or not to execute the switching from the autonomous driving control to the manual driving is determined based on a comparison between a comparison target and a threshold. Here, the comparison target is quantified so as to be compared with the threshold. When the comparison target is equal to or more than the threshold, the autonomous driving apparatus 100 executes the switching from the running autonomous driving control to the manual driving.

For example, when an operation amount of any of a steering operation, an acceleration operation, and a brake operation by the driver of the vehicle during the autonomous driving control becomes equal to or more than a threshold, the autonomous driving apparatus 100 executes the switching from the running autonomous driving control to the manual driving.

The manual driving is a driving status that makes the vehicle run in accordance mainly with a driving operation by the driver. For example, the manual driving includes a driving status that makes the vehicle run in accordance only with a driving operation by the driver. Moreover, the manual driving includes a driving status in which the vehicle runs in accordance mainly with a driving operation by the driver while a driving operation support control that supports the driving operation by the driver is additionally performed.

An example of the driving operation support control performed during the manual driving is as follows. The driver actively performs any of a steering operation, an acceleration operation, and a brake operation of the vehicle, while the autonomous driving apparatus 100 performs any of the steering operation, the acceleration operation, and the brake operation of the vehicle that is not performed by the driver.

In the example shown in FIG. 1, the autonomous driving apparatus 100 is provided with an external sensor 1, an GPS (Global Positioning System) reception unit 2, an internal sensor 3, a map database 4, a navigation system 5, actuators 6, an HMI (Human Machine Interface) 7, a driver status detection unit 8, a tutorial switch 9, auxiliary devices 50, and an ECU (Electronic Control Unit) 10.

In the example shown in FIG. 1, the external sensor 1 is a detector that detects external circumstances as surrounding information of the vehicle. The external sensor 1 includes at least one of a camera, a radar, and a LIDAR (Laser Imaging Detection and Ranging).

The camera is an imaging device that images the external circumstances surrounding the vehicle. For example, the camera is provided on a back side of a front windshield of the vehicle. The camera may be a monocular camera or a stereo camera. For example, the stereo camera has two imaging units arranged to recreate binocular disparity. Image information obtained by the stereo camera includes information in a depth direction. The camera outputs, to the ECU 10, image information on the external circumstances surrounding the vehicle. The camera is not limited to a visible camera but can be an infrared camera.

The radar uses radio waves to detect obstacles outside of the vehicle. For example, the radio wave is millimeter wave. The radar transmits the radio waves to the surroundings of the vehicle and receives reflected radio waves from an obstacle to detect the obstacle. For example, the radar can detect, as obstacle information regarding the obstacle, a distance to the obstacle or a direction toward the obstacle. The radar outputs the detected obstacle information to the ECU 10. When performing a sensor fusion, the radar may output, to the ECU 10, reception information of the reflected radio waves.

The LIDAR uses lights to detect obstacles outside of the vehicle. The LIDAR transmits a light to the surroundings of the vehicle and receives reflected light from an obstacle to measure a distance to the reflected point and detect the obstacle. For example, the LIDAR can detect, as obstacle information regarding the obstacle, a distance to the obstacle or a direction toward the obstacle. The LIDAR outputs the detected obstacle information to the ECU 10. When performing a sensor fusion, the LIDAR may output, to the ECU 10, reception information of the reflected lights. Note that the camera, the radar, and the LIDAR do not necessarily need to be used redundantly.

In the example shown in FIG. 1, the GPS reception unit 2 receives signals from three or more GPS satellites to obtain position information indicating a position of the vehicle. For example, the position information includes latitude information and longitude information. The GPS reception unit 2 outputs the measured position information of the vehicle to the ECU 10.

As another example, another means for identifying a latitude and a longitude of a position of the vehicle may be used instead of the GPS reception unit 2.

In the example shown in FIG. 1, the internal sensor 3 is a detector for detecting information depending on a running status of the vehicle and an operation amount of any of a steering operation, an acceleration operation, and a brake operation by the driver of the vehicle. The internal sensor 3 includes at least one of a vehicle speed sensor, an acceleration sensor, and a yaw rate sensor for detecting the information depending on the running status of the vehicle. Moreover, the internal sensor 3 includes at least one of a steering sensor, an accelerator pedal sensor, and a brake pedal sensor for detecting the operation amount.

In the example shown in FIG. 1, the internal sensor 3 serves as a driving operation detection unit.

The vehicle speed sensor is a detector that detects a speed of the vehicle. For example, a wheel speed sensor is used as the vehicle speed sensor. The wheel speed sensor is provided to a wheel of the vehicle or a drive shaft rotating together with the wheel and detects a rotational speed of the wheel. The vehicle speed sensor outputs, to the ECU 10, vehicle speed information (wheel speed information) including the speed of the vehicle.

The acceleration sensor is a detector that detects an acceleration of the vehicle. For example, the acceleration sensor includes a longitudinal acceleration sensor for detecting a longitudinal acceleration of the vehicle and a lateral acceleration sensor for detecting a lateral acceleration of the vehicle. The acceleration sensor outputs, to the ECU 10, acceleration information including the acceleration of the vehicle.

The yaw rate sensor is a detector that detects a yaw rate (rotation angular velocity) around a vertical axis passing through the center of gravity of the vehicle. For example, a gyro sensor is used as the yaw rate sensor. The yaw rate sensor outputs, to the ECU 10, yaw rate information including the yaw rate of the vehicle.

The steering sensor is a detector that detects a steering operation amount of a steering operation with respect to the steering wheel by the driver of the vehicle. The steering operation amount detected by the steering sensor is a steering angle of the steering wheel or a steering torque applied to the steering wheel, for example. The steering sensor is provided to a steering shaft of the vehicle, for example. The steering sensor outputs, to the ECU 10, information including the steering angle of the steering wheel or the steering torque applied to the steering wheel.

The accelerator pedal sensor is a detector that detects a stroke amount of an accelerator pedal. The stroke amount of the accelerator pedal is, for example, a pedal position of the accelerator pedal with respect to a reference position. The reference position may be a fixed position or a variable position depending on a predetermined parameter. The accelerator pedal sensor is provided to a shaft portion of the accelerator pedal of the vehicle, for example. The accelerator pedal sensor outputs, to the ECU 10, operation information depending on the stroke amount of the accelerator pedal.

The brake pedal sensor is a detector that detects a stroke amount of a brake pedal. The stroke amount of the brake pedal is, for example, a pedal position of the brake pedal with respect to a reference position. The reference position may be a fixed position or a variable position depending on a predetermined parameter. The brake pedal sensor is provided to a shaft portion of the brake pedal, for example. The brake pedal sensor may detect an operation force of the brake pedal (e.g. force on the brake pedal, oil pressure of a master cylinder, and so force). The brake pedal sensor outputs, to the ECU 10, operation information depending on the stroke amount or the operation force of the brake pedal.

In the example shown in FIG. 1, the map database 4 is a database including map information. The map database 4 is implemented, for example, in an HDD (Hard Disk Drive) installed in the vehicle. The map information includes road position information, road shape information, intersection position information, and fork position information, for example. The road shape information includes a road type such as a curve and a straight line, and a curvature of the curve. When the autonomous driving apparatus 100 uses a SLAM (Simultaneous Localization and Mapping) technology or position information of blocking structural objects such as buildings and walls, the map information may further include an output signal from the external sensor 1.

As another example, the map database 4 may be constructed in a computer in a facility such as an information processing center with which the vehicle can communicate.

In the example shown in FIG. 1, the navigation system 5 is a device that guides the driver of the vehicle to a destination on the map designated by the driver of the vehicle.

The navigation system 5 calculates a route in which the vehicle runs, based on the position information of the vehicle measured by the GPS reception unit 2 and the map information of the map database 4. The route may indicate a running lane in which the vehicle runs in a section having a plurality of lanes, for example. The navigation system 5 calculates a target route from the current position of the vehicle to the destination, and notifies the driver of the target route through a display and a speaker (audio output) for example. The navigation system 5 outputs, to the ECU 10, information of the target route for the vehicle.

In the example shown in FIG. 1, the navigation system 5 uses the position information of the vehicle measured by the GPS reception unit 2 and the map information of the map database 4. In another example, the navigation system 5 may use information stored in a computer in a facility such as an information processing center with which the vehicle can communicate. A part of the processing executed by the navigation system 5 may be executed by the computer in the facility.

In the example shown in FIG. 1, the actuators 6 are devices that execute running controls of the vehicle. The actuators 6 include at least a throttle actuator, a brake actuator, and a steering actuator.

In the example shown in FIG. 1, the throttle actuator controls, in accordance with a control signal output from the ECU 10, an air amount supplied to an engine (i.e. throttle opening) to control a driving force of the vehicle.

In another example where the vehicle is an electric vehicle, the actuators 6 may not include the throttle actuator but include a motor as a power source. A control signal is supplied from the ECU 10 to the motor, and thereby the driving force is controlled.

The brake actuator controls, in accordance with a control signal output from the ECU 10, a brake system to control a braking force applied to each wheel of the vehicle. For example, a hydraulic brake system can be used as the brake system.

The steering actuator controls, in accordance with a control signal output from the ECU 10, driving of an assist motor of an electric power steering system that controls the steering torque. Thus, the steering actuator controls the steering torque of the vehicle.

In the example shown in FIG. 1, the HMI 7 is an interface used for communicating information between an occupant (including the driver) in the vehicle and the autonomous driving apparatus 100. For example, the HMI 7 includes a display panel for displaying image information for the occupant, a speaker for outputting audio information, and operation buttons or a touch panel used by the occupant for performing an input operation. The HMI 7 may transmit the information to the occupant through a mobile information terminal connected wirelessly and receive the input operation by the occupant through the mobile information terminal.

In the example shown in FIG. 1, the driver status detection unit 8 detects a status of an occupant (including the driver) in the vehicle.

For example, the driver status detection unit 8 can check whether or not the driver has a strong driving intention. Whether or not the driver has a strong driving intention is determined by the tutorial availability estimation unit 20 described later, based on a result of the detection by the driver status detection unit 8. The tutorial availability estimation unit 20 estimates whether or not a tutorial can be started.

For example, a driver monitor (a camera for taking an image of a face of the driver) serves as the driver status detection unit 8. For example, when the driver monitor detects distracted driving or drowsy driving, the tutorial availability estimation unit 20 determines that the driving intention of the driver is low.

For example, it is possible to detect an eyelid, a black eye and the like based on inputs from the driver monitor (the camera for taking the image of the face of the driver), template matching, and brightness information to determine whether or not the driver is performing the distracted driving or drowsy driving.

For example, when the driver status detection unit 8 detects that a direction of eyes of the driver does not change from a certain direction for more than a certain period of time, the tutorial availability estimation unit 20 determines that the driving intention of the driver is low.

Moreover, the driver status detection unit 8 can check whether or not safety of the occupant is high. Whether or not the safety of the occupant is high is determined by the tutorial availability estimation unit 20, based on a result of the detection by the driver status detection unit 8.

For example, when the driver status detection unit 8 detects that the occupant does not wear a seat belt, the tutorial availability estimation unit 20 determines that the safety of the occupant is low.

For example, the driver status detection unit 8 can detect whether or not the occupant wears the seat belt by using a sensor to detect whether or not a belt-side tongue plate and a buckle engage with each other.

For example, when the driver status detection unit 8 detects that any door is opening, the tutorial availability estimation unit 20 determines that the safety of the occupant is low.

For example, when the driver status detection unit 8 detects that the driver reclines a seat too much, the tutorial availability estimation unit 20 determines that the safety of the occupant is low.

As an example, a reclining sensor provided to a power seat serves as the driver status detection unit 8 and detects that the driver reclines the seat too much. As another example, a pressure sensor installed in the seat serves as the driver status detection unit 8, and a reclining posture can be estimated based on a body pressure distribution detected by the pressure sensor.

In the example shown in FIG. 1, a tutorial switch 9 is provided. In the example shown in FIG. 1, the autonomous driving apparatus 100 is configured to be able to execute a tutorial that is an explanation of an operation by a driver required for switching from the autonomous driving control to manual driving.

For example, when the driver thinks that the tutorial is necessary, the driver turns ON the tutorial switch 9. On the other hand, when the driver thinks that the tutorial is not necessary or when the driver feels that a display of the tutorial is annoying, the driver turns OFF the tutorial switch 9.

In the example shown in FIG. 1, the tutorial switch 9 is in ON state in default settings of the autonomous driving apparatus 100.

In the example shown in FIG. 1, the auxiliary devices 50 include devices that can be operated by the driver of the vehicle. The auxiliary devices 50 include a collection of devices that are not included in the actuators 6.

In the example shown in FIG. 1, the auxiliary devices 50 include a direction indicator, a headlight, a windshield wiper and the like.

In the example shown in FIG. 1, the ECU 10 (controller) executes the autonomous driving control of the vehicle. The ECU 10 has a CPU (Central Processing Unit), a ROM (Read Only Memory), a RAM (Random Access Memory) and the like.

In the example shown in FIG. 1, the ECU 10 (controller) includes an acquisition unit 11, a recognition unit 12, a navigation plan generation unit 13, a calculation unit 14, a display unit 15, a control unit 16, a tutorial availability estimation unit 20, a tutorial determination unit 21, and a scenario generation unit 22. In the ECU 10, a program stored in the ROM is loaded onto the RAM and executed by the CPU, and thereby controls by the acquisition unit 11 and the like are executed. The ECU 10 may consist of a plurality of electric control units.

In the example shown in FIG. 1, the acquisition unit 11 obtains the following operation amounts based on the information obtained by the internal sensor 3: the operation amounts of the steering operation, the acceleration operation, and the brake operation by the driver of the vehicle during the autonomous driving control; and the operation amounts of the steering operation, the acceleration operation, and the brake operation by the driver of the vehicle during the manual driving. As an example, the operation amounts are the steering angle of the steering wheel, the steering torque applied to the steering wheel, the stroke amount of the accelerator pedal, the stroke amount of the brake pedal, and the operation force of the brake pedal. As another example, the operation amounts are duration times during which the steering angle of the steering wheel, the steering torque applied to the steering wheel, the stroke amount of the accelerator pedal, the stroke amount of the brake pedal, and the operation force of the brake pedal are equal to or more than predetermined thresholds, respectively.

In the example shown in FIG. 1, the internal sensor 3 and the acquisition unit 11 serves as a “vehicle information detection unit”. More specifically, based on vehicle information obtained by the internal sensor 3 and the acquisition unit 11, for example, the tutorial availability estimation unit 20 can determine whether or not the vehicle is in a stable state and whether or not a part of the vehicle is failed.

For example, when the internal sensor 3 and the acquisition unit 11 detect that a VSC (Vehicle Stability Control) control is in execution, the tutorial availability estimation unit 20 determines that the vehicle is in an unstable state.

For example, when the internal sensor 3 and the acquisition unit 11 detect that an ABS (Antilock Brake System) control is in execution, the tutorial availability estimation unit 20 determines that the vehicle is in an unstable state.

For example, when the internal sensor 3 and the acquisition unit 11 detect that a TRC (TRaction Control) is in execution, the tutorial availability estimation unit 20 determines that the vehicle is in an unstable state.

For example, when the internal sensor 3 and the acquisition unit 11 detect that a PCS (Pre-Crash Safety) is activated, the tutorial availability estimation unit 20 determines that the vehicle is in an unstable state.

For example, when the internal sensor 3 and the acquisition unit 11 detect that an LDA (Lane Departure Alert) is activated, the tutorial availability estimation unit 20 determines that the vehicle is in an unstable state.

For example, when the internal sensor 3 and the acquisition unit 11 detect a sudden acceleration, a sudden deceleration, or a zigzag driving of the vehicle, the tutorial availability estimation unit 20 determines that the vehicle is in an unstable state.

For example, when the ECU 10 recognizes failure or temporal defect of a part such as the external sensor 1, the GPS reception unit 2, and the internal sensor 3, the tutorial availability estimation unit 20 determines that the part of the vehicle is failed.

For example, when the ECU 10 recognizes failure or temporal defect of a part such as the navigation system 5, the actuator 6, the HMI 7, and the auxiliary device 50, the tutorial availability estimation unit 20 determines that the part of the vehicle is failed.

For example, when failure or temporal defect of the ECU 10 occurs, the tutorial availability estimation unit 20 determines that a part of the vehicle is failed.

For example, when the ECU 10 recognizes decrease in a power-supply voltage supplied to components of the autonomous driving apparatus 100, the tutorial availability estimation unit 20 determines that a part of the vehicle is failed.

For example, when an unstable state such as communication blackout occurs in a component of the autonomous driving apparatus 100, the tutorial availability estimation unit 20 determines that a part of the vehicle is failed.

In the example shown in FIG. 1, the recognition unit 12 recognizes an environment surrounding the vehicle, based on the information obtained by the external sensor 1, the GPS reception unit 2, and the map database 4. For example, the recognition unit 12 includes an obstacle recognition unit (not shown), a road width recognition unit (not shown), and a facility recognition unit (not shown).

The obstacle recognition unit recognizes, based on the information obtained by the external sensor 1, obstacles surrounding the vehicle as the environment surrounding the vehicle. For example, the obstacles recognized by the obstacle recognition unit include moving objects such as pedestrians, other vehicles, motorcycles, and bicycles and stationary objects such as a road lane boundary (white line, yellow line), a curb, a guard rail, poles, a median strip, buildings and trees. The obstacle recognition unit obtains information regarding a distance between the obstacle and the vehicle, a position of the obstacle, a direction, a relative velocity, a relative acceleration of the obstacle with respect to the vehicle, and a category and attribution of the obstacle. The category of the obstacle includes a pedestrian, another vehicle, a moving object, and a stationary object. The attribution of the obstacle means a property of the obstacle such as hardness and a shape of the obstacle.

The road width recognition unit recognizes, based on the information obtained by the external sensor 1, the GPS reception unit 2, and the map database 4, a road width of a road in which the vehicle is running, as the environment surrounding the vehicle.

The facility recognition unit recognizes, based on the map information obtained from the map database 4 and the vehicle position information obtained by the GPS reception unit 2, whether or not the vehicle is running in any of an intersection and a parking, as the environment surrounding the vehicle. The facility recognition unit may recognize, based on the map information and the vehicle position information, whether or not the vehicle is running in a school zone, near a childcare facility, near a school, or near a park, as the environment surrounding the vehicle.

In the example shown in FIG. 1, the recognition unit 12 serves as a “surrounding environment recognition unit”. More specifically, based on the surrounding environment of the vehicle recognized by the recognition unit 12, the tutorial availability estimation unit 20 determines whether or not a risk of the surrounding environment of the vehicle is low.

For example, when the recognition unit 12 recognizes that a TTC (Time To Collision) between the vehicle and a following vehicle, a preceding vehicle or a lateral vehicle is less than a predetermined value, the tutorial availability estimation unit 20 determines that the risk of the surrounding environment of the vehicle is high.

For example, when the recognition unit 12 recognizes that the vehicle is close to a pedestrian, a bicycle or a motorcycle and the vehicle is likely to come into contact with the pedestrian, bicycle or motorcycle, the tutorial availability estimation unit 20 determines that the risk of the surrounding environment of the vehicle is high.

For example, when the recognition unit 12 recognizes that the vehicle is running in a low-μ road, the tutorial availability estimation unit 20 determines that the risk of the surrounding environment of the vehicle is high.

In the example shown in FIG. 1, the navigation plan generation unit 13 generates a navigation plan (target track) for the vehicle, based on the target route calculated by the navigation system 5, the information on the obstacles surrounding the vehicle recognized by the recognition unit 12, and the map information obtained from the map database 4. More specifically, the navigation plan generation unit 13 generates a plan of navigation of the vehicle carried out by the autonomous driving control, and serves as a target track generation unit.

The navigation plan is a track of the vehicle in the target route. For example, the navigation plan includes a speed, an acceleration, a deceleration, a direction, and a steering angle of the vehicle at each time.

The navigation plan generation unit 13 generates the navigation plan such that the vehicle runs on the target route while satisfying criteria of safety, legal compliance, a running efficiency and the like. Moreover, based on the situation of the obstacles surrounding the vehicle, the navigation plan generation unit 13 generates the navigation plan for the vehicle so as to avoid contact with the obstacles.

In the example shown in FIG. 1, the calculation unit 14 calculates a threshold used for determining whether or not the autonomous driving control can be started, a threshold used for determining whether or not the tutorial can be started, and the like.

When display of the tutorial is in execution, the driver tends to pay attention to the tutorial rather than the driving operation or an operation for starting the autonomous driving control. Therefore, in the example shown in FIG. 1, the threshold used for determining whether or not the tutorial can be started is set to be a larger value than the threshold used for determining whether or not the autonomous driving control can be started.

As a result, in the example shown in FIG. 1, the determination, by the tutorial availability estimation unit 20 and the tutorial determination unit 21, that the tutorial can be started is less likely to be made than the determination, by the control unit Id, that the autonomous driving control can be started.

That is, in the example shown in FIG. 1, a determination condition used by the tutorial availability estimation unit 20 and the tutorial determination unit 21 for determining that the tutorial can be started is set to be less likely to be met than a determination condition used by the control unit 16 for determining that the autonomous driving control can be started.

In the example shown in FIG. 1, the display unit 15 can display, on a display of the HMI 7, the threshold used for determining whether or not the autonomous driving control can be started, the threshold used for determining whether or not the tutorial can be started, and the like that are calculated by the calculation unit 14.

More specifically, the display unit 15 can display, on the display of the HMI 7, the threshold used for determining whether or not the autonomous driving control can be started when the manual driving is in execution. Moreover, the display unit 15 can display, on the display of the HMI 7, the threshold used for determining whether or not the tutorial can be started when the tutorial is not executed.

Moreover, in the example shown in FIG. 1, the display unit 15 can notify the driver of a fact that the autonomous driving control is in execution and a fact that the autonomous driving control is not in execution.

When the autonomous driving control is started, the display unit 15 displays, on the display of the HMI 7 for example, a fact that the autonomous driving control is in execution.

When the switching from the autonomous driving control to the manual driving is executed, the display unit 15 displays, on the display of the HMI 7 for example, a fact that the autonomous driving control is not in execution (i.e. a fact that the manual driving is in execution).

In the example shown in FIG. 1, the control unit 16 automatically controls driving of the vehicle based on the navigation plan generated by the navigation plan generation unit 13. The control unit 16 outputs, to the actuators 6, control signals according to the navigation plan. That is, the control unit 16 controls the actuators 6 based on the navigation plan, and thereby the autonomous driving control of the vehicle is executed. In another word, in the example shown in FIG. 1, the control unit 16 serves as a vehicle motion control unit.

Moreover, when the operation amount of the driving operation by the driver, which is obtained by the acquisition unit 11, becomes equal to or more than the threshold calculated by the calculation unit 14 in a period during which the autonomous driving control is in execution, the control unit 16 executes the switching from the autonomous driving control to the manual driving.

In the example shown in FIG. 1, the control unit 16 includes a determination unit that determines whether or not the autonomous driving control by the autonomous driving apparatus 100 can be started. That is, in the example shown in FIG. 1, the determination unit of the control unit 16 serves as a “first determination unit” that determines whether or not the autonomous driving control can be started.

For example, the determination unit of the control unit 16 calculates a comparison target by quantifying a difference between a vehicle position calculated from the signals received by the GPS reception unit 2 and an actual vehicle position calculated based on an output signal from the external sensor 1 and map information included in the map database 4. The determination unit of the control unit 16 makes a comparison between the comparison target and the threshold calculated by the calculation unit 14. When the comparison target is equal to or more than the threshold, the determination unit determines that the autonomous driving control can be started.

Here, as the difference becomes smaller, the comparison target is calculated to be larger and thus it is more likely to be determined that the autonomous driving control can be started.

More specifically, in the example shown in FIG. 1, a value of the comparison target obtained by quantifying the difference corresponds to reliability of the vehicle position. The reliability is defined in a range from 0 to 100, for example. A threshold A, which is the threshold used for determining whether or not the autonomous driving control can be started, is set to “70” for example. When the reliability is equal to or more than the threshold A (70), that is, when the reliability of the vehicle position is high, it is determined that the autonomous driving control can be started.

Meanwhile, in the example shown in FIG. 1, a threshold B, which is the threshold used for determining whether or not the tutorial can be started, is set to be larger than the threshold A. For example, the threshold B is set to “95” (>threshold A). When the reliability is equal to or more than the threshold B (95), that is, when the reliability of the vehicle position is extremely high, it is determined that the tutorial can be started.

In other words, in the example shown in FIG. 1, a determination condition for determining that the tutorial can be started is less likely to be met (set to be tighter) than a determination condition for determining that the autonomous driving control can be started.

The threshold for determining that the tutorial can be started is set to be larger than the threshold for determining that the autonomous driving control can be started. The threshold is not limited to the above-mentioned threshold regarding the reliability of the vehicle position. Other examples of the threshold include a threshold regarding reliability of recognition of the environment surrounding the vehicle by the recognition unit 12, a threshold regarding reliability of generation (track generation) of the navigation plan for the vehicle by the navigation plan generation unit 13, a threshold regarding reliability of an output of the autonomous driving control, and so forth.

For example, in a poor weather condition, the reliability of recognition of the environment surrounding the vehicle by the recognition unit 12 is low. For example, when there are a large number of obstacles around the vehicle, the reliability of recognition of the environment surrounding the vehicle by the recognition unit 12 is low.

For example, when the reliability of the vehicle position becomes low, the reliability of generation (track generation) of the navigation plan for the vehicle by the navigation plan generation unit 13 also becomes low. When the reliability of recognition of the environment surrounding the vehicle by the recognition unit 12 becomes low, the reliability of generation (track generation) of the navigation plan for the vehicle by the navigation plan generation unit 13 also becomes low.

In the autonomous driving apparatus according to the first embodiment, the above-mentioned reliability is described by a physical quantity or a dimensionless physical quantity and is compared with a predetermined threshold to make the determination.

As another example, the determination unit of the control unit 16 can determine, based on curvature of a road in which the vehicle is running, whether or not the autonomous driving control can be started.

For example, the determination unit of the control unit 16 calculates a comparison target by quantifying the curvature of the road in which the vehicle is running, and makes a comparison between the comparison target and the threshold calculated by the calculation unit 14. When the comparison target is equal to or more than the threshold, the determination unit determines that the autonomous driving control can be started.

Here, as the curvature of the road in which the vehicle is running becomes smaller, the comparison target is calculated to be larger and thus it is more likely to be determined that the autonomous driving control can be started.

As still another example, the determination unit of the control unit 16 can determine, based on the operation amount (for example, the steering operation amount) of the driving operation by the driver of the vehicle during the manual driving obtained by the acquisition unit 11, whether or not the autonomous driving control can be started.

For example, the determination unit of the control unit 16 calculates a comparison target by quantifying the operation amount of the driving operation by the driver of the vehicle during the manual driving, and makes a comparison between the comparison target and the threshold calculated by the calculation unit 14. When the comparison target is equal to or more than the threshold, the determination unit determines that the autonomous driving control can be started.

Here, as the operation amount of the driving operation by the driver of the vehicle during the manual driving becomes smaller, the comparison target is calculated to be larger and thus it is more likely to be determined that the autonomous driving control can be started.

In the example shown in FIG. 1, start of the autonomous driving control is triggered by a driver's operation. More specifically, an ignition (not shown) of the vehicle is first turned ON. Subsequently, based on the environments surrounding the vehicle recognized by the external sensor 1 and the recognition unit 12 of the ECU 10, the control unit 16 determines whether or not the autonomous driving control can be started. When the autonomous driving control can be started, the control unit 16 uses the HMI 7 to notify the driver of the fact that the autonomous driving control can be started. Then, the driver performs a predetermined input operation by using the HMI 7. In response to that, the autonomous driving apparatus 100 starts the autonomous driving control.

In the example shown in FIG. 1, whether or not the tutorial can be started is determined by the tutorial availability estimation unit 20 and the tutorial determination unit 21. That is, in the example shown in FIG. 1, the tutorial availability estimation unit 20 and the tutorial determination unit 21 serves as a “second determination unit” that determines whether or not the tutorial can be started.

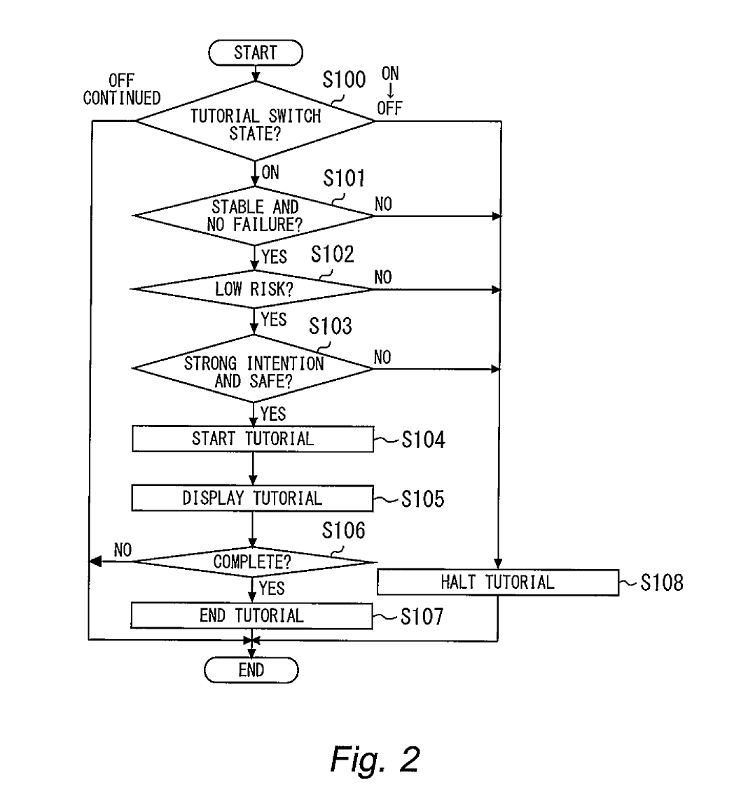

FIG. 2 is a flow chart for explaining the determination of whether or not the tutorial can be started in the autonomous driving apparatus according to the first embodiment.

A routine shown in FIG. 2 is executed at a predetermined interval. After the routine shown in FIG. 2 is started, a state of the tutorial switch 9 (see FIG. 1) is first determined at Step S100. When the tutorial switch 9 is in ON state, the process proceeds to Step S101. When the tutorial switch 9 is turned from ON to OFF, the process proceeds to Step S108. When the tutorial switch 9 is maintained in OFF state, the routine is ended.

At Step S101, the tutorial availability estimation unit 20 (see FIG. 1) determines, based on the vehicle information obtained by the internal sensor 3 (see FIG. 1) and the acquisition unit 11 (see FIG. 1) for example, whether or not the vehicle is in a stable state and whether or not a part of the vehicle is failed.

When the tutorial availability estimation unit 20 determines that the vehicle is in an unstable state, the process proceeds to Step S108. Also, when the tutorial availability estimation unit 20 determines that a part of the vehicle is failed, the process proceeds to Step S108. When the tutorial availability estimation unit 20 determines that the vehicle is in a stable state and there is no failure of a part of the vehicle, the process proceeds to Step S102.

At Step S102, the tutorial availability estimation unit 20 (see FIG. 1) determines, based on the surrounding environment of the vehicle recognized by the recognition unit 12 (see FIG. 1) for example, whether or not a risk of the surrounding environment of the vehicle is low.

When the tutorial availability estimation unit 20 determines that the risk of the surrounding environment of the vehicle is high, the process proceeds to Step S108. When the tutorial availability estimation unit 20 determines that the risk of the surrounding environment of the vehicle is low, the process proceeds to Step S103.

At Step S103, the tutorial availability estimation unit 20 (see FIG. 1) determines, based on the result of the detection by the driver status detection unit 8 (see FIG. 1) for example, whether or not the driver has a strong driving intention and whether or not the safety of the occupant is high.

When the tutorial availability estimation unit 20 determines that the driving intention of the driver is low, the process proceeds to Step S108. Also, when the tutorial availability estimation unit 20 determines that the safety of the occupant is low, the process proceeds to Step S108. When the tutorial availability estimation unit 20 determines that the driver has a strong driving intention and the safety of the occupant is high, the process proceeds to Step S104.

That is, in the example shown in FIG. 2, at Steps S101, S102, and S103, the tutorial availability estimation unit 20 determines whether or not there is possibility that the driver falls into an unsafe situation if the driver executes the operation required for the switching from the autonomous driving control to the manual driving. When there is possibility that the driver falls into an unsafe situation if the driver executes the operation required for the switching from the autonomous driving control to the manual driving, the determination at any of Steps S101, S102, and S103 results in “NO”. On the other hand, when there is no possibility that the driver falls into an unsafe situation even if the driver executes the operation required for the switching from the autonomous driving control to the manual driving, the determination at each of Steps S101, S102, and S103 results in “YES”.

At Step S104, the tutorial is started. That is, when it is determined at Step S100 that the tutorial switch 9 (see FIG. 1) is in ON state and when the tutorial availability estimation unit 20 determines at Step S101, S102, and S103 that the tutorial can be started, the tutorial determination unit 21 (see FIG. 1) gives permission to start the tutorial at Step S104, and thereby the tutorial is started.

Next, at Step S105, the tutorial is displayed for the driver through the display of the HMI 7 (see FIG. 1) and the like. As a result, the driver can learn the driver's operation required for the switching from the autonomous driving control to the manual driving.

A scenario of the tutorial that the autonomous driving apparatus 100 should display for the driver varies depending on a situation where the switching from the autonomous driving control to the manual driving is executed. Therefore, in the autonomous driving apparatus 100 according to the first embodiment, a plurality of scenarios are predetermined respectively for various situations where the switching from the autonomous driving control to the manual driving is executed.

More specifically, in the autonomous driving apparatus 100 according to the first embodiment, a scenario that explains the driver's operation required for the switching from the autonomous driving control to the manual driving when the vehicle is suddenly decelerated during the autonomous driving control is predetermined, for example. Moreover, scenarios that explain the driver's operations required for the switching from the autonomous driving control to the manual driving in the following cases are respectively predetermined: that is, a case where the vehicle is suddenly accelerated during the autonomous driving control; a case where the vehicle cannot start moving during the autonomous driving control; a case where the vehicle suddenly moves within a lane; a case where the vehicle suddenly changes lanes during the autonomous driving control; a case where the vehicle reaches a limit point of the autonomous driving control during the autonomous driving control.

More specifically, at Step S105, the scenario generation unit 22 (see FIG. 1) selects an optimum scenario from the above-mentioned predetermined scenarios, and the tutorial with the selected optimum scenario is displayed for the driver.

More specifically, at Step S105, whether or not there is any executable scenario among the plurality of predetermined scenarios is judged based on the result of recognition of the environment surrounding the vehicle. When there is only one executable scenario, the one executable scenario is selected as the optimum scenario, and the tutorial with the selected scenario is displayed for the driver. On the other hand, when there are a plurality of executable scenarios, one of the plurality of executable scenarios is selected as the optimum scenario, and the tutorial with the selected scenario is displayed for the driver.

As another example, at Step S105, whether or not there is any executable scenario among the plurality of predetermined scenarios may be judged based on the navigation plan for the vehicle generated by the navigation plan generation unit 13 (see FIG. 1).

Next, at Step S106, whether or not the display of the tutorial is completed is determined by the ECU 10 (see FIG. 1) for example. When the display of the tutorial is not yet completed, the current routine is ended. When the display of the tutorial is completed, the process proceeds to Step S107.

At Step S107, for example, the ECU 10 ends the tutorial.

On the other hand, at Step S108, for example, the tutorial determination unit 21 (see FIG. 1) halts the tutorial.

That is, in the example shown in FIG. 2, Steps S100, S101, S102, and S103 are executed at a predetermined interval even after the tutorial is started at Step S104 and during a period when the display of the tutorial is in execution at Step S105. If it is determined at Step S100 that the tutorial switch 9 (see FIG. 1) is turned from ON to OFF by the driver, if the determination at Step S101 results in “NO”, if the determination at Step S102 results in “NO”, or if the determination at Step S103 results in “NO”, Step S108 is executed and the tutorial determination unit 21 halts the currently displayed tutorial.

The tutorial availability estimation unit 20 (see FIG. 1) that executes the above-mentioned Steps S101, S102, and S103 has a function of predicting a risk in a period when the display of the tutorial is in execution.

As shown in FIG. 1, the autonomous driving apparatus 100 according to the first embodiment is provided with the tutorial switch 9, the tutorial availability estimation unit 20, the tutorial determination unit 21, and the scenario generation unit 22 and is configured to be able to perform the tutorial that is the explanation of the driver's operation required for the switching from the autonomous driving control to the manual driving.

Therefore, in the case of the autonomous driving apparatus 100 according to the first embodiment, it is possible to suppress the possibility that the switching from the autonomous driving control to the manual driving cannot be executed even though the driver desires the switching from the autonomous driving control to the manual driving, as compared with a case where the autonomous driving apparatus is not configured to be able to perform the tutorial.

Furthermore, according to the autonomous driving apparatus 100 of the first embodiment, the determination condition used by the tutorial availability estimation unit 20 and the tutorial determination unit 21 for determining that the tutorial can be started is less likely to be met than the determination condition used by the control unit 16 for determining that the autonomous driving control can be started. That is, according to the autonomous driving apparatus 100 of the first embodiment, the tutorial is started under a safer situation than a situation when the autonomous driving control can be started. In accordance with the tutorial, the driver performs the operation required for the switching from the autonomous driving control to the manual driving.

Therefore, according to the autonomous driving apparatus 100 of the first embodiment, it is possible to suppress the possibility that the tutorial is started and the driver performs the operation required for the switching from the autonomous driving control to the manual driving under a situation where the safety is insufficient.

In other words, according to the autonomous driving apparatus 100 of the first embodiment, the driver can safely learn and safely perform the operation required for the switching from the autonomous driving control to the manual driving.

In the example shown in FIG. 2, the tutorial availability estimation unit 20 (see FIG. 1) determines whether or not the tutorial can be started, after the driver turns ON the tutorial switch 9 (see FIG. 1). As another example, it is also possible that the tutorial availability estimation unit 20 first notifies the driver of the determination that the tutorial can be started, and then the driver turns ON the tutorial switch 9 to start the tutorial.

In the example shown in FIG. 2, the determination condition for permitting the switching from the autonomous driving control to the manual driving is the same between when the display of the tutorial at Step S105 is in execution and when the display of the tutorial is not in execution. As another example, it is also possible that the determination condition for permitting the switching from the autonomous driving control to the manual driving when the display of the tutorial is in execution is set to be looser than the determination condition for permitting the switching from the autonomous driving control to the manual driving when the display of the tutorial is not in execution.

### Second Embodiment

A second embodiment of the autonomous driving apparatus according to the present invention will be described hereinafter.

The configuration of the autonomous driving apparatus of the second embodiment is almost the same as the autonomous driving apparatus of the above-described first embodiment, except for points which will be described later. Therefore, according to the autonomous driving apparatus of the second embodiment, almost the same effects as in the case of the autonomous driving apparatus of the above-mentioned first embodiment can be achieved, except for the points which will be described later.

The autonomous driving apparatus of the second embodiment is configured similarly to the autonomous driving apparatus 100 of the first embodiment as shown in FIG. 1. In the autonomous driving apparatus 100 of the second embodiment, a scheduled action of the autonomous driving apparatus 100 is checked (recognized), for example by the ECU 10, based on the navigation plan generated by the navigation plan generation unit 13. In other words, in the autonomous driving apparatus 100 according to the second embodiment, for example, the ECU 10 serves as a “scheduled action check unit” that checks (recognizes), based on the navigation plan generated by the navigation plan generation unit 13, a scheduled action of the autonomous driving apparatus 100.

Moreover, according to the autonomous driving apparatus 100 of the second embodiment, in the ECU 10 for example, the scheduled action of the autonomous driving apparatus 100 checked by the ECU 10 is compared with the scenario generated by the scenario generation unit 22 to determine whether or not the scheduled action is consistent with the scenario. In other words, in the autonomous driving apparatus 100 according to the second embodiment, for example, the ECU 10 serves as a “third determination unit” that compares the scheduled action of the autonomous driving apparatus 100 with the scenario generated by the scenario generation unit 22 to determine whether or not the scheduled action is consistent with the scenario.

In the autonomous driving apparatus 100 of the second embodiment, a plurality of scenarios are predetermined respectively for various situations where the switching from the autonomous driving control to the manual driving is executed, as in the case of the autonomous driving apparatus 100 of the first embodiment.

More specifically, in the autonomous driving apparatus 100 of the second embodiment, for example, a scenario that explains the driver's operation required for the switching from the autonomous driving control to the manual driving in the following case is predetermined: that is, a case where there is an obstacle within a lane in which the vehicle can run and thus the vehicle continues to stop for a certain period of time during the autonomous driving control. For example, when traffic restriction is being performed due to a road work and the like, it may not easy for the autonomous driving apparatus 100 to judge whether or not the vehicle can depart from the lane.

Moreover, in the autonomous driving apparatus 100 of the second embodiment, for example, a scenario that explains the driver's operation required for the switching from the autonomous driving control to the manual driving in the following case is predetermined: that is, a case where curvature of a road in which the vehicle is running becomes large during the autonomous driving control and thus the vehicle reaches a limit point of the autonomous driving control. For example, such the case where curvature of a road in which the vehicle is running becomes large during the autonomous driving control and thus the vehicle reaches a limit point of the autonomous driving control may occur when the vehicle travels along a mountain road.

Furthermore, in the autonomous driving apparatus 100 of the second embodiment, for example, a scenario that explains the driver's operation required for the switching from the autonomous driving control to the manual driving in the following case is predetermined: that is, a case where a traffic jam extends from before an intersection beyond the intersection and thus the vehicle continues to stops before the intersection for a certain period of time during the autonomous driving control. In this case, it may not easy for the autonomous driving apparatus 100 to judge whether or not the vehicle can enter the intersection and temporarily stop within the intersection.

Meanwhile, in the autonomous driving apparatus 100 of the second embodiment, scenarios that explain the driver's operations required for the switching from the autonomous driving control to the manual driving in the following cases are not predetermined: that is, a case where the vehicle is suddenly decelerated during the autonomous driving control; a case where the vehicle is suddenly accelerated during the autonomous driving control; and a case where a quick steering of the vehicle is required during the autonomous driving control. That is, in the autonomous driving apparatus 100 of the second embodiment, the tutorial is not displayed for the driver when the vehicle is suddenly decelerated during the autonomous driving control, when the vehicle is suddenly accelerated during the autonomous driving control, and when a quick steering of the vehicle is required during the autonomous driving control.

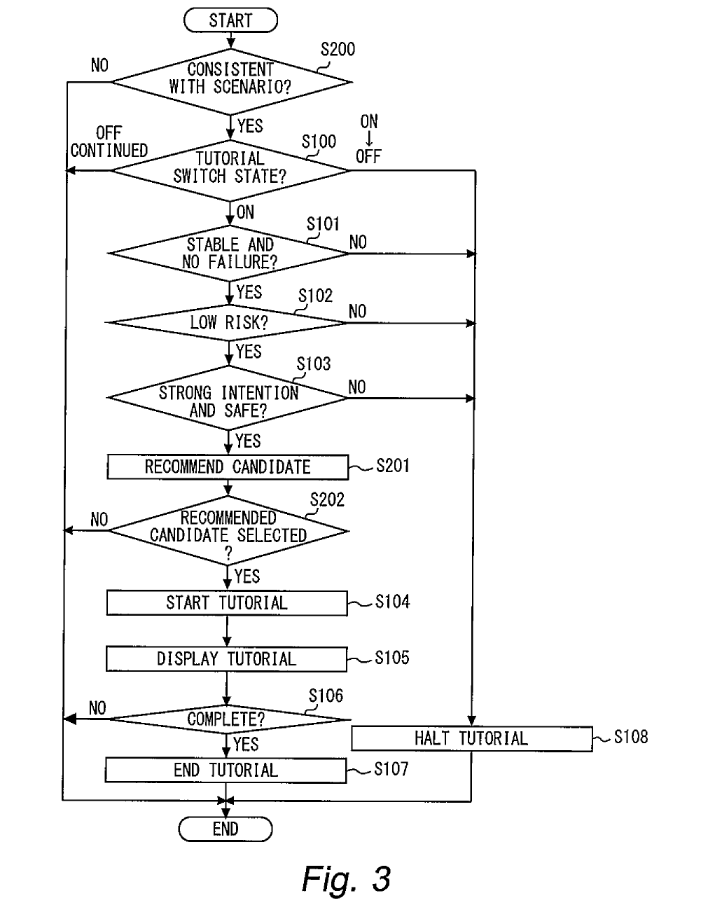

FIG. 3 is a flow chart for explaining the determination of whether or not the tutorial can be started in the autonomous driving apparatus according to the second embodiment.

A routine shown in FIG. 3 is executed at a predetermined interval, as in the case of the routine shown in FIG. 2. After the routine shown in FIG. 3 is started, Step S200 is first performed, where whether or not the scheduled action of the autonomous driving apparatus 100 checked by the ECU 10 (see FIG. 1) is consistent with the scenario generated by the scenario generation unit 22 (see FIG. 1) is determined by the ECU 10 for example. If the determination results in “YES”, the process proceeds to Step S100, otherwise the current routine is ended.

At Step S100, the same processing as Step S100 in FIG. 2 is carried out. That is, when it is determined at Step S100 that the tutorial switch 9 is in ON state, the process proceeds to Step S101. When it is determined at Step S100 that the tutorial switch 9 is turned from ON to OFF, the process proceeds to Step S108. When it is determined at Step S100 that the tutorial switch 9 is maintained in OFF state, the routine is ended.

At Step S101, the same processing as Step S101 in FIG. 2 is carried out. That is, when it is determined at Step S101 that the vehicle is in an unstable state, the process proceeds to Step S108. Also, when it is determined at Step S101 that a part of the vehicle is failed, the process proceeds to Step S108. When it is determined at Step S101 that the vehicle is in a stable state and there is no failure of a part of the vehicle, the process proceeds to Step S102.

At Step S102, the same processing as Step S102 in FIG. 2 is carried out. That is, when it is determined at Step S102 that the risk of the surrounding environment of the vehicle is high, the process proceeds to Step S108. When it is determined at Step S102 that the risk of the surrounding environment of the vehicle is low, the process proceeds to Step S103.

At Step S103, the same processing as Step S103 in FIG. 2 is carried out. That is, when it is determined at Step S103 that the driving intention of the driver is low, the process proceeds to Step S108. Also, when it is determined at Step S103 that the safety of the occupant is low, the process proceeds to Step S108. When it is determined at Step S103 that the driver has a strong driving intention and the safety of the occupant is high, the process proceeds to Step S201.

In the autonomous driving apparatus 100 according to the second embodiment, a “candidate scenario” is recommended to the driver by the ECU 10 for example. The candidate scenario is selected from the scenario that is determined to be consistent with the scheduled action of the autonomous driving apparatus 100. With the candidate scenario, the driver can execute the operation required for the switching from the autonomous driving control to the manual driving. That is, in the autonomous driving apparatus 100 of the second embodiment, the ECU 10 serves as a “candidate scenario recommendation unit” that recommends, to the driver, a candidate scenario that is the scenario determined to be consistent with the scheduled action of the autonomous driving apparatus 100 and with which the driver can execute the operation required for the switching from the autonomous driving control to the manual driving.

At Step S201, the ECU 10 recommends, to the driver, a candidate scenario that is the scenario determined to be consistent with the scheduled action of the autonomous driving apparatus 100 and with which the driver can execute the operation required for the switching from the autonomous driving control to the manual driving. After that, the process proceeds to Step S202.

For example, in the second embodiment, a scenario that explains the driver's operation required for the switching from the autonomous driving control to the manual driving in the following case is predetermined: that is, a case where there is a parked vehicle ahead of the vehicle and the vehicle changes lanes in order to avoid the parked vehicle during the autonomous driving control.

Here, if there is another vehicle approaching from the behind to pass the vehicle, changing lanes may cause danger. Considering this point, in the example shown in FIG. 3, if there is another vehicle approaching from the behind to pass the vehicle and changing lanes may cause danger, the above-mentioned scenario, which explains the driver's operation required for the switching from the autonomous driving control to the manual driving when the vehicle changes lanes, is not recommended to the driver at Step S201. Instead, at Step S201, another scenario among the scenarios determined at Step S200 to be consistent with the scheduled action of the autonomous driving apparatus 100 is recommended, as the candidate scenario, to the driver.

In other words, in the example shown in FIG. 3, such a scenario that a dangerous situation is not caused when the driver executes the operation required for the switching from the autonomous driving control to the manual driving in accordance with the scenario is selected from the scenarios determined at Step S200 to be consistent with the scheduled action of the autonomous driving apparatus 100. Then, the selected scenario is recommended, as the candidate scenario, to the driver.

In the autonomous driving apparatus 100 according to the second embodiment, whether or not the recommended candidate scenario is selected by the driver is determined by the ECU 10 (see FIG. 1) for example. That is, in the autonomous driving apparatus 100 according to the second embodiment, the ECU 10 serves as a “fourth determination unit” that determines whether or not the recommended candidate scenario is selected by the driver.

At Step S202, the ECU 10 determines whether or not the recommended candidate scenario is selected by the driver. If the determination results in “YES”, the process proceeds to Step S104, otherwise the current routine is ended.

In the example shown in FIG. 3, the candidate scenario, which is determined not to cause a dangerous situation when the driver executes the operation required for the switching from the autonomous driving control to the manual driving in accordance with the scenario, is recommended to the driver by the autonomous driving apparatus 100. When the driver selects one scenario from the recommended candidate scenario, the determination at Step S202 results in “YES”.

At Step S104, the same processing as Step S104 in FIG. 2 is carried out. Then, the process proceeds to Step S105.

At Step S105, the same processing as Step S105 in FIG. 2 is carried out. Then, the process proceeds to Step S106.

More specifically, in the example shown in FIG. 3, the candidate scenario, which is determined not to cause a dangerous situation when the driver executes the operation required for the switching from the autonomous driving control to the manual driving in accordance with the scenario, is recommended to the driver by the autonomous driving apparatus 100. One of the recommended candidate scenario is selected by the driver. At Step S105, the scenario generation unit 22 (see FIG. 1) displays the tutorial with the selected scenario for the driver.

At Step S106, the same processing as Step S106 in FIG. 2 is carried out. More specifically, at Step S106, when the display of the tutorial with the scenario selected by the driver is not yet completed, the current routine is ended. When the display of the tutorial with the scenario selected by the driver is completed, the process proceeds to Step S107.

At Step S107, the same processing as Step S107 in FIG. 2 is carried out.

At Step S108, the same processing as Step S108 in FIG. 2 is carried out.

As described above, in the example shown in FIG. 3, the tutorial is started at Step S104, if it is determined at Step S200 that the scheduled action of the autonomous driving apparatus 100 and the scenario generated by the scenario generation unit 22 are consistent with each other and it is determined at Step S202 that the candidate scenario recommended at Step S201 is selected by the driver.

In other words, according to the autonomous driving apparatus 100 of the second embodiment, the tutorial to be started at Step S104 (see FIG. 3) is about the operation recommended (at Step S201) by the autonomous driving apparatus 100 as an operation that the driver can execute in safety and selected (at Step S202) by the driver, among the driver's operation required for the switching from the autonomous driving control to the manual driving.

That is, according to the autonomous driving apparatus 100 of the second embodiment, the tutorial to be started at Step S104 (see FIG. 3) is about the operation that is safe and desired by the driver, among the driver's operation required for the switching from the autonomous driving control to the manual driving. In accordance with the tutorial, the driver performs the operation for switching from the autonomous driving control to the manual driving.

Therefore, according to the autonomous driving apparatus 100 of the second embodiment, it is possible to improve the safety of the driver's operation for switching from the autonomous driving control to the manual driving and to improve the driver's attention to the tutorial, as compared with a case where a tutorial about an operation with low safety or an operation in which the driver's desire is not reflected is started.

### Third Embodiment

A third embodiment of the autonomous driving apparatus according to the present invention will be described hereinafter.

The configuration of the autonomous driving apparatus of the third embodiment is almost the same as the autonomous driving apparatus of the above-described first embodiment, except for points which will be described later. Therefore, according to the autonomous driving apparatus of the third embodiment, almost the same effects as in the case of the autonomous driving apparatus of the above-mentioned first embodiment can be achieved, except for the points which will be described later.

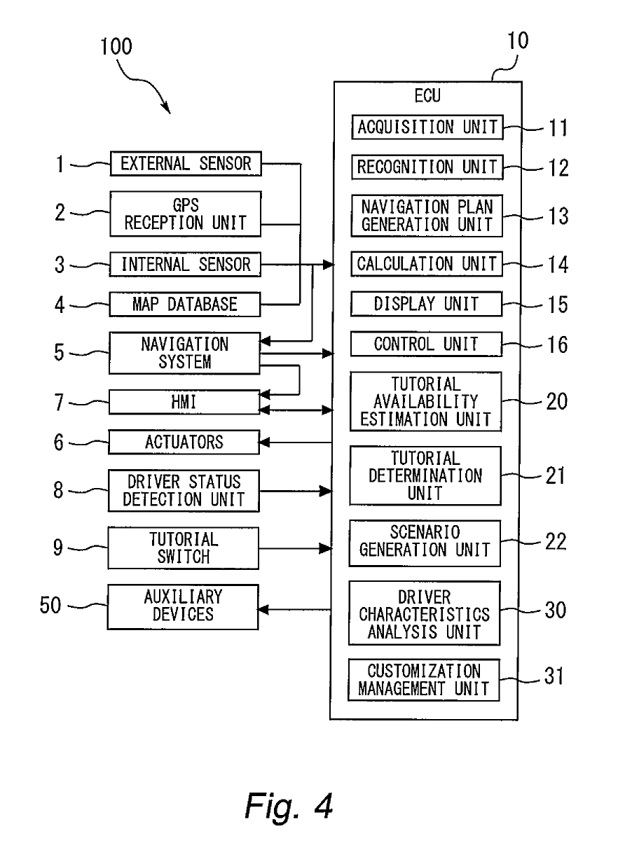

FIG. 4 is a schematic configuration diagram of the autonomous driving apparatus according to the third embodiment.

In the example shown in FIG. 4, the ECU 10 further includes: a driver characteristics analysis unit 30 that analyzes characteristics of the driver based on a result of execution of the tutorial; and a customization management unit 31 that changes settings of the autonomous driving apparatus 100 based on the characteristics of the driver analyzed by the driver characteristics analysis unit 30.

For example, the driver characteristics analysis unit 30 analyzes characteristics of the driver based on the number of times of execution of the display of the tutorial, the operation amount and the operation speed of the driver's operation for the switching from the autonomous driving control to the manual driving when the display of the tutorial is in execution (that is, a response of the driver to the display of the tutorial), or the like.

More specifically, normal values of a frequency of execution of the display of the tutorial by normal users, the operation amount and the operation speed of the operation by the normal users for the switching from the autonomous driving control to the manual driving when the display of the tutorial is in execution, or the like are predetermined and stored in the driver characteristics analysis unit 30. The driver characteristics analysis unit 30 analyzes the characteristics of the driver by comparing the number of times of execution of the display of the tutorial, the operation amount and the operation speed of the driver's operation for the switching from the autonomous driving control to the manual driving when the display of the tutorial is in execution with the normal values.

Based on a result of the analysis of the driver's characteristics such as the operation amount and the operation speed (i.e. a time required for the operation) of the driver's operation for the switching from the autonomous driving control to the manual driving when the display of the tutorial is in execution, the customization management unit 31 changes (customizes) the settings of the autonomous driving apparatus 100 and reflects the result of the analysis of the driver's characteristics in generation of the navigation plan (target track) by the navigation plan generation unit 13.

More specifically, for example, when the operation speed of the driver's operation for the switching from the autonomous driving control to the manual driving when the display of the tutorial is in execution is low, the customization management unit 31 changes (customizes) the settings to improve sensitivity of an alert and attention calling provided to the driver through the HMI 7. More specifically, the customization management unit 31 changes (customizes) the settings such that the alert and the attention calling are started earlier than usual.

Other examples of items to be customized by the customization management unit 31 include a target vehicle speed during the autonomous driving control, a distance between the vehicle and surrounding vehicles during the autonomous driving control, a stop position of the vehicle when there is an obstacle ahead of the vehicle during the autonomous driving control, maximum values and time differential values of each of the acceleration and the deceleration during the autonomous driving control, maximum values and time differential values of the steering amount during the autonomous driving control, and the like.

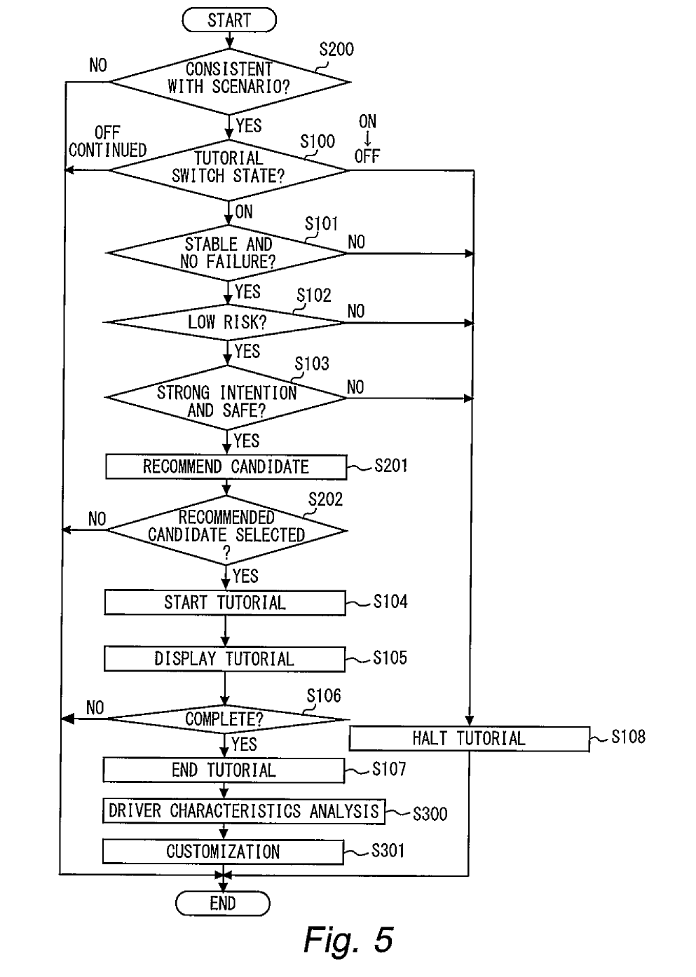

FIG. 5 is a flow chart for explaining the determination of whether or not the tutorial can be started in the autonomous driving apparatus according to the third embodiment.

A routine shown in FIG. 5 is executed at a predetermined interval, as in the case of the routine shown in FIG. 3. Processing from Step S200 to Step S107 is the same as the processing from Step S200 to Step S107 shown in FIG. 3.

In the example shown in FIG. 5, Step S107 is followed by Step S300.

At Step S300, the driver characteristics analysis unit 30 (see FIG. 4) analyzes characteristics of the driver, for example, based on the number of times of execution of the display of the tutorial, the operation amount and the operation speed of the driver's operation for the switching from the autonomous driving control to the manual driving when the display of the tutorial is in execution, or the like.

Subsequently, at Step S301, the customization management unit 31 (see FIG. 4) changes (customizes) the settings of the autonomous driving apparatus 100.

As described above, according to the autonomous driving apparatus 100 of the third embodiment, the characteristics of the driver are analyzed based on the result of execution of the tutorial, and the settings of the autonomous driving apparatus 100 are changed based on the characteristics of the driver. That is, the result of execution of the tutorial is reflected in the customization of the autonomous driving apparatus 100.

Therefore, according to the autonomous driving apparatus 100 of the third embodiment, it is possible to make the settings of the autonomous driving apparatus 100 suitable for the driver and thus improve the driver's confidence in the autonomous driving apparatus 100, as compared with a case where the settings of the autonomous driving apparatus 100 are not changed based on the characteristics of the driver.

In the example shown in FIGS. 4 and 5, the customization management unit 31 performs customization of the autonomous driving apparatus 100, based on the characteristics of the driver analyzed by the driver characteristics analysis unit 30. In another example, the customization management unit 31 can perform customization of not only the autonomous driving apparatus 100 but also a section of the vehicle other than the autonomous driving apparatus 100, based on the characteristics of the driver analyzed by the driver characteristics analysis unit 30.

### Fourth Embodiment

In a fourth embodiment of the autonomous driving apparatus according to the present invention, some of the first to third embodiments and examples of the autonomous driving apparatus according to the present invention described above can be combined with each other as appropriate.

What is claimed is:

1. An autonomous driving apparatus that executes an autonomous driving control of a vehicle,
the autonomous driving apparatus comprising:
a tutorial switch; and
a controller configured to:
determine whether or not the autonomous driving control can be started; and
determine whether or not a tutorial can be started, the tutorial being an explanation of an operation by a driver required for switching from the autonomous driving control to manual driving,
wherein a determination condition for determining that the tutorial can be started is less likely to be met than a determination condition for determining that the autonomous driving control can be started, and
wherein the tutorial is started when the tutorial switch is in ON state and the controller determines that the tutorial can be started.

2. The autonomous driving apparatus according to claim 1,
wherein the controller is further configured to:
generate a plan of navigation carried out by the autonomous driving control;
check, based on the generated plan of navigation, a scheduled action of the autonomous driving apparatus;
generate a scenario;
compare the scheduled action of the autonomous driving apparatus with the scenario to determine whether or not the scheduled action is consistent with the scenario;
recommend, to the driver, a candidate scenario that is the scenario determined to be consistent with the scheduled action of the autonomous driving apparatus and with which the driver can execute the operation required for the switching from the autonomous driving control to the manual driving; and
determine whether or not the recommended candidate scenario is selected by the driver,
wherein the scenario generated by the controller is predetermined, and
wherein the tutorial is started when the controller determines that the scheduled action of the autonomous driving apparatus is consistent with the scenario and the controller determines that the recommended candidate scenario is selected by the driver.

3. The autonomous driving apparatus according to claim 2,
wherein the controller is further configured to:
analyze characteristics of the driver based on a result of execution of the tutorial; and
change settings of the autonomous driving apparatus based on the characteristics of the driver.
